(19) United States
(12) Patent Application Publication
(10) Pub. No.: US 2017/0079888 A1
(43) Pub. Date: Mar. 23, 2017

(54) Bottle Holding Harness

(71) Applicants: Erin K. Palmer, Campbell, CA (US); Jennifer Bezuk, Campbell, CA (US)

(72) Inventors: Erin K. Palmer, Campbell, CA (US); Jennifer Bezuk, Campbell, CA (US)

(21) Appl. No.: 14/858,721

(22) Filed: Sep. 18, 2015

(51) Int. Cl. A61J 9/06; A45F 5/00

(52) U.S. Cl. CPC A61J 9/0676; A45F 5/00; A61J 9/0638

(57) ABSTRACT

A bottle holding harness assembly includes a harness to be placed on an upper torso of an adult. The harness has a back side and a front side and a front strap is attached front side of the harness. A saddle is mounted on the front strap. The saddle i releasably receives a bottle and the saddle is rotatable with respect to the front strap.

### BACKGROUND OF THE DISCLOSURE

Field of the Disclosure

The disclosure relates to bottle holding devices and more particularly pertains to a new bottle holding device wearable by a person for holding a bottle adjacent to a face of a child while the person is feeding the child.

### SUMMARY OF THE DISCLOSURE

An embodiment of the disclosure meets the needs presented above by generally comprising a harness configured to be placed on an upper torso of an adult. The harness has a back side and a front side and a front strap is attached front side of the harness. A saddle is mounted on the front strap. The saddle is configured to releasably receive a bottle. The saddle is rotatable with respect to the front strap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a bottle holding harness assembly according to an embodiment of the disclosure.

FIG. 2 is a rear view of an embodiment of the disclosure.

FIG. 3 is a rear perspective view of an embodiment of the disclosure.

FIG. 4 is a front view of an embodiment of the disclosure.

FIG. 5 is a top view of an embodiment of the disclosure.

FIG. 6 is a side view of an embodiment of the disclosure.

FIG. 7 is an enlarged broken cross-sectional view of a mount an embodiment of the disclosure.

### DESCRIPTION OF THE PREFERRED EMBODIMENT

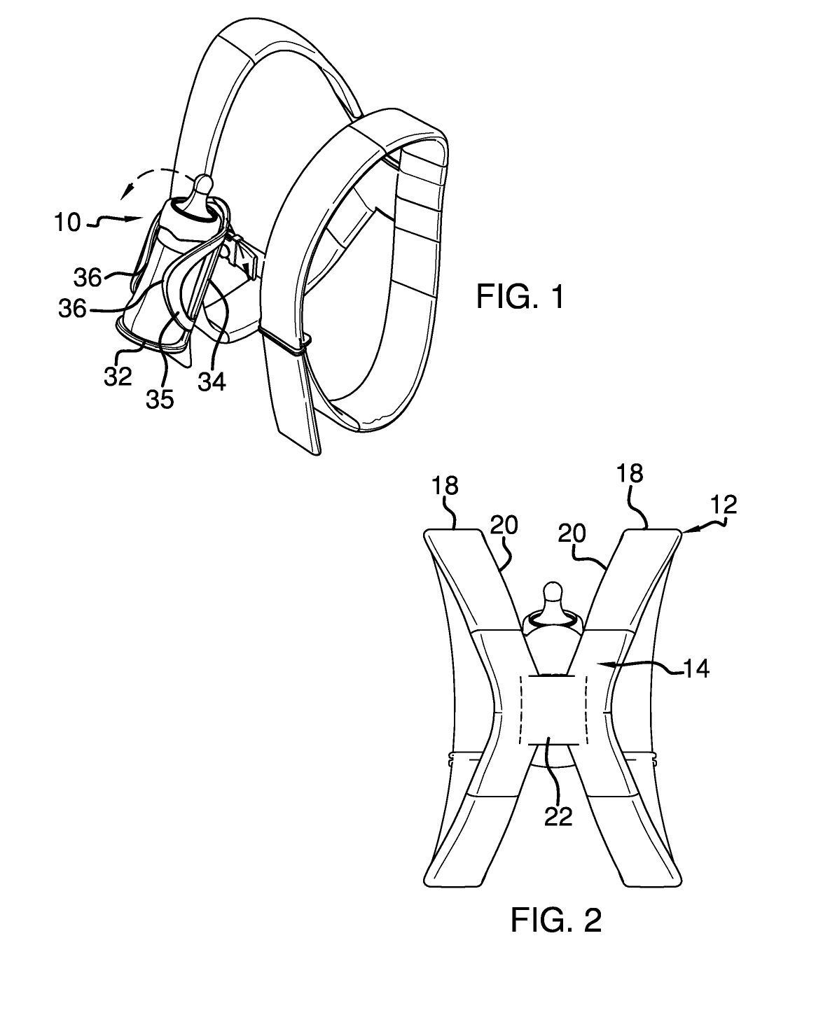

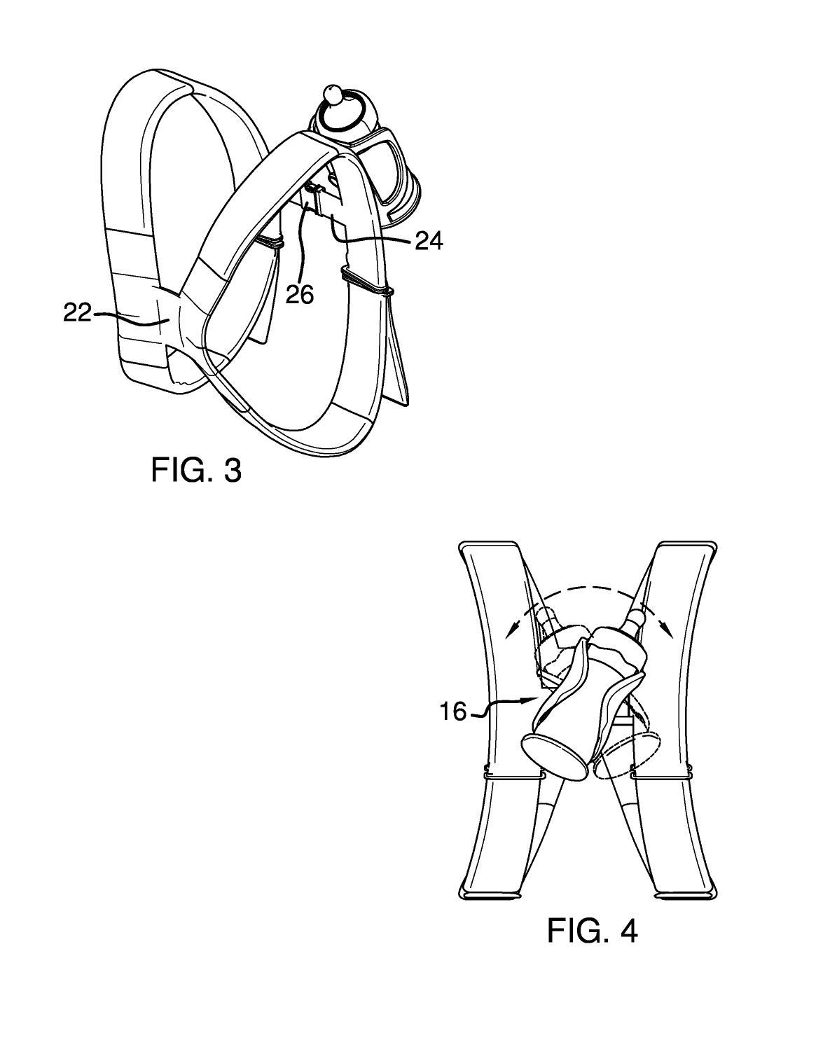

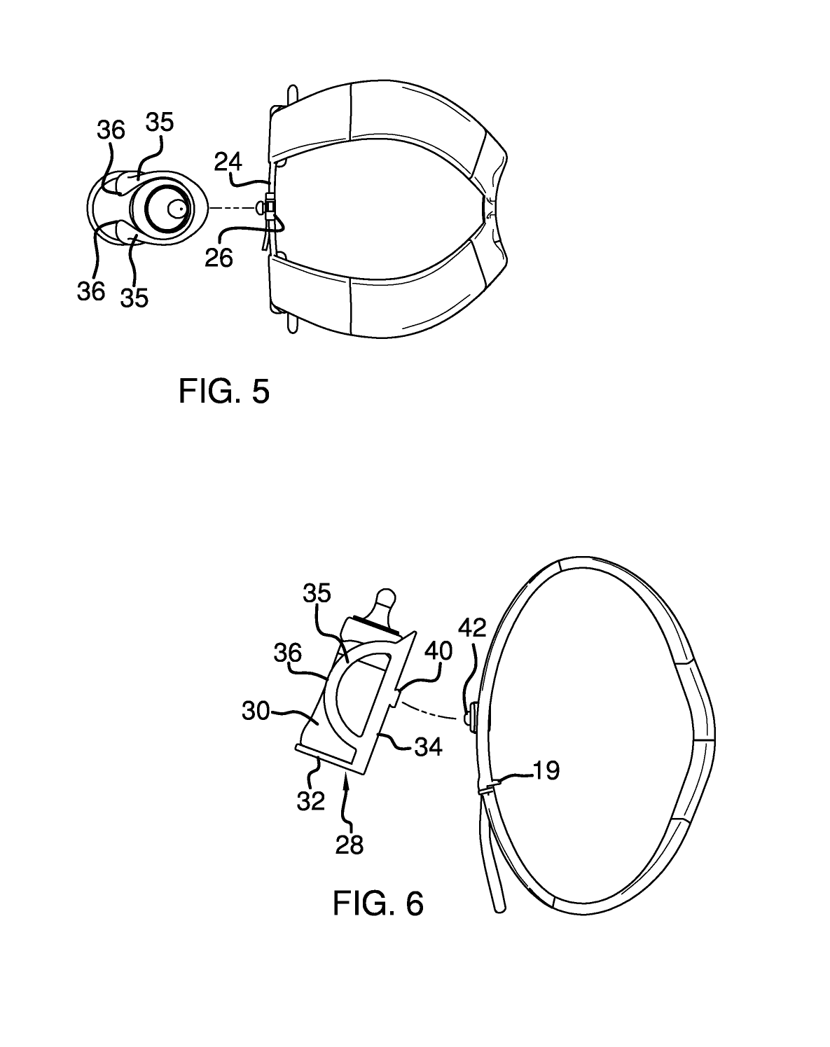

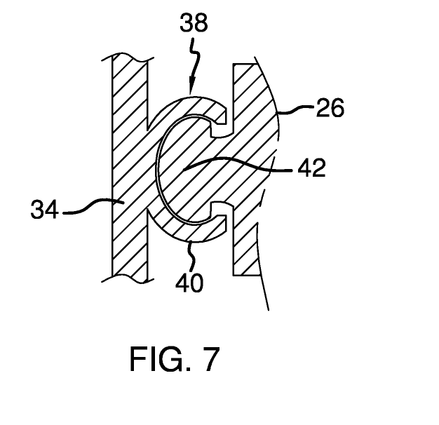

With reference now to the drawings, and in particular to FIGS. 1 through 7 thereof, a new bottle holding device embodying the principles and concepts of an embodiment of the disclosure and generally designated by the reference numeral 10 will be described.

As best illustrated in FIGS. 1 through 7, the bottle holding harness assembly 10 generally comprises a harness 12 configured to be placed on an upper torso of an adult. The harness 12 has a back side 14 and a front side 16. More particularly, the harness 12 includes a pair of loops 18 wherein each of the loops 18 has an inner edge 20 with respect to each other and the inner edges 20 of the loops 18 face each other. A back strap 22 is attached to the back side 14 of the harness 12 and extends between the inner edges 20 of the loops 18. Each of the loops 18 is configured to receive an arm of an adult such that the back strap 22 is positioned on a back of the adult. A front strap 24 is attached to the front side 16 of the harness 12 and extends between the inner edges 20 of the loops 18. The front strap 24 includes a pair of strap sections attached together with a generally conventional buckle 26. The loops 18 and front strap 24 may each have a selectively adjustable length. The harness 12 may be comprised out of a cloth material, plastic material, or combinations thereof. The loops 18 may include stops 19 to prevent over-tightening of the loops 18.

A saddle 28 is mounted on the front strap 24 and is configured to releasably receive a bottle 30. The saddle 28 includes a bottom wall 32 and a back wall 34 that is attached to and extends upwardly from the bottom wall 32. A pair of lateral walls 35 is attached to the back wall 34 and extends forwardly therefrom. The lateral walls 35 each have a distal edge 36 with respect to the back wall 34. The lateral walls 35 arc towards each other from the back wall 34 to the distal edges 36 such that the lateral walls will 34 extend partially around the bottle 30 when the bottle 30 is placed on the bottom wall 32. The lateral walls 34 are comprised of a resiliently bendable material to facilitate frictionally engaging the bottle 30. A mount 38 is attached to the back wall 34 and the mount 38 engages the strap 24. The mount 38 is rotatable with respect to the front strap 24. This may be done any number of conventional manners such as, for instance, having the mount 38 comprise a female receiver 40 which receives a ball shaped male coupler 42 that is extendable into the female receiver 40 and which allows the female receiver 40 to rotate on the male coupler 42. The mount 38 may be positioned on the buckle 26.

In use, the harness 12 is placed on the adult in a conventional manner such that the saddle 28 is positioned below the face of the child. A bottle 30 is then placed in the saddle 28 so that it is easily accessible to the child being held by the adult. The saddle 28 is rotatable to allow the bottle to be rotated to either side depending on how the adult is holding the child. The saddle 28 prevents the need of the adult having to hold the bottle while feeding the child.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bottle holding assembly configured for being worn by an adult while feeding a child, said assembly comprising:
a harness configured to be placed on an upper torso of an adult, said harness having a back side and a front side, a front strap being attached to said front side of said harness; and
a saddle being mounted on said front strap, said saddle being configured to releasably receive a bottle, said saddle being rotatable with respect to said front strap.

2. The bottle holding assembly according to claim 1, wherein said harness includes a pair of loops, said loops each having an inner edge with respect to each other, said inner edges of said loops facing each other, a back strap being attached to said back side of said harness and extending between said inner edges of said loops, wherein each of said loops is configured to receive an arm of the adult such that said back strap is positioned on a back of the adult.

3. The bottle holding assembly according to claim 1, wherein said front strap includes a pair of strap sections attached together with a buckle.

4. The bottle holding assembly according to claim 1, wherein said saddle includes a bottom wall and a back wall being attached to and extending upwardly from said bottom wall, a pair of lateral walls being attached to said back wall and extending forwardly therefrom, said lateral walls each having a distal edge with respect to said back wall, said lateral walls arcing towards each other from said back wall to said distal edges.

5. The bottle holding assembly according to claim 4, wherein said lateral walls are comprised of a resiliently bendable material.

6. The bottle holding assembly according to claim 4, further including a mount being attached to said back wall, said mount engaging said front strap, said mount being rotatable with respect to said front strap.

7. A bottle holding assembly configured for being worn by an adult while feeding a child, said assembly comprising:
a harness configured to be placed on an upper torso of an adult, said harness having a back side and a front side, said harness including a pair of loops, said loops each having an inner edge with respect to each other, said inner edges of said loops facing each other, a back strap being attached to said back side of said harness and extending between said inner edges of said loops, wherein each of said loops is configured to receive an arm of the adult such that said back strap is positioned on a back of the adult, a front strap being attached to said front side of said harness, said front strap extending between said inner edges of said loops, said front strap including a pair of strap sections attached together with a buckle;
a saddle being mounted on said front strap, said saddle being configured to releasably receive a bottle, said saddle including a bottom wall and a back wall being attached to and extending upwardly from said bottom wall, a pair of lateral walls being attached to said back wall and extending forwardly therefrom, said lateral walls each having a distal edge with respect to said back wall, said lateral walls arcing towards each other from said back wall to said distal edges, said lateral walls being comprised of a resiliently bendable material; and
a mount being attached to said back wall, said mount engaging said front strap, said mount being rotatable with respect to said front strap.
